(19) United States
(12) Patent Application Publication
(10) Pub. No.: US 2024/0371237 A1
(43) Pub. Date: Nov. 7, 2024

(54) STORAGE CASSETTE AND DISPENSING METHOD FOR TICKETS

(71) Applicant: IGT Global Solutions Corporation, Providence, RI (US)

(72) Inventor: Jérôme Froidevaux, Saignelégier (CH)

(21) Appl. No.: 18/599,447

(22) Filed: Mar. 8, 2024

(30) Foreign Application Priority Data
May 4, 2023 (CH) CH000481/2023

(51) Int. Cl. G07F 17/42

(52) U.S. Cl. CPC G07F 17/42

(57) ABSTRACT

A cassette for automatically dispensing tickets, comprising an adjustable end-stop device comprising a rear end-stop provided with a positioning device and with a locking device and a positioning reference fixed on the framework, a method for loading such a cassette with tickets of variable size, and a method for dispensing such tickets.

### PRIORITY

This application claims priority to and the benefit of Swiss Patent Application No. CH000481/2023, filed May 4, 2023, the entire contents of which are incorporated herein by reference.

### BACKGROUND

The present disclosure relates to a lottery-ticket storage cassette configured for automatically dispensing tickets. In various embodiments, the present disclosure relates to a cassette configurable to suit several formats of lottery tickets. In various embodiments, the present disclosure relates to a method for filling a dispensing cassette. In various embodiments, the present disclosure relates to a method for automatically dispensing lottery tickets from a dispensing cassette.

The growing increase in the quantity of lottery tickets, particularly scratch card games or instant-win lottery tickets comes with a diversification of lottery ticket formats.

Faced with the increasing demand for such lottery games, self-service automatic dispensers are often installed in public places or thoroughfares such as railway stations or other commercial outlets. Such automatic dispensers are often adapted to suit one or a few predefined ticket formats, thereby limiting their field of use. Specifically, many automatic dispensers cannot be adapted to suit the full range of lottery tickets available at any moment. Further, certain lottery tickets are removed from the market in favour of new lottery tickets of different formats, making certain automatic dispensers obsolete.

Another challenge lies in the reliability of the automatic dispensers, particularly in the control of the dispensed lottery tickets. For such automatic dispensers, it is important that only the lottery tickets purchased be able to be dispensed. For such automatic dispensers, it is also important that a purchased lottery ticket be able to be delivered to the purchaser without remaining jammed in the dispenser. Reliability aspects adopt an increasing level of importance the greater the diversity of the lottery tickets delivered. It is therefore important to be able to offer a wide choice of lottery tickets while at the same time ensuring that they will be dispensed reliably.

Aside from the reliability aspects, the diversity of the lottery tickets offered for sale requires increasingly great storage volumes, with a corresponding effect on the dimensions of the dispensers. However, the space available for the dispensers often remains tight, particularly when the dispensers are situated in small commercial outlets, and this limits what can be offered.

Another aspect of the automatic dispensing of lottery tickets relates to the handling that the filling of the dispensers entails, this requiring the lottery tickets to be placed correctly in their housing to prevent any problem during dispensing. A greater diversity of lottery tickets often requires the handling of a greater number of trays. Further, the positioning of the lottery tickets can be dependent on their format, and this increases loading times.

One known proposed automatic lottery-ticket dispenser is provided with several dispensing cassettes and with a mobile robot enabling a lottery ticket to be dispensed from one or another of these cassettes according to the choice made by the customer. The dispensing cassettes can be adapted to suit several different lottery ticket formats.

There is still a need to improve one or more of the above-mentioned aspects, particularly the possibility of combining the dispensing of a very diverse range lottery tickets and high dispensing reliability and/or reduced space requirement.

### BRIEF SUMMARY

Various embodiments of the present disclosure provide a cassette for storing booklets of lottery tickets, wherein the cassette configured to be positioned in a lottery ticket automatic dispenser. The cassette includes a framework including a bottom bordered by two lateral edges, by a front face, and by a rear face; and an adjustable end-stop device supported by the framework. The adjustable end-stop device includes: a rear end-stop including a lottery ticket first bearing surface, a positioning device, and a locking device; and a positioning reference secured to the framework and configured to co-act with the positioning device. The positioning reference is positioned on a rear portion of the framework along a longitudinal axis so that the rear end-stop is positionable along said longitudinal axis. The locking device is configured to keep the rear end-stop secured to the framework in a determined position.

Various other embodiments of the present disclosure provide a cassette for storing booklets of lottery tickets, wherein the cassette is configured to be positioned in an automatic dispenser. The cassette includes a framework including a bottom bordered by two lateral edges, by a front face, and by a rear face. The cassette also includes an adjustable end-stop device supported by the framework, wherein the adjustable end-stop device includes a rear end-stop including a lottery ticket first bearing surface, a rear end-stop baseplate at a position rearwardly to the lottery ticket first bearing surface, the baseplate including a first surface inclined towards the front face and configured to raise first ends of lottery tickets in contact with said lottery ticket first bearing surface. The cassette also includes a front end-stop secured to the framework, the front end-stop comprising a lottery ticket second bearing surface that faces the lottery ticket first bearing surface, the front end-stop comprising a front end-stop baseplate in a position rearwardly of the lottery ticket second bearing surface, the front end-stop baseplate including a second rearwardly inclined surface and configured to raise second ends of lottery tickets in contact with said lottery ticket second bearing surface.

Various other embodiments of the present disclosure provide a cassette for storing booklets of lottery tickets, wherein the cassette configured to be positioned in an automatic dispenser. The cassette includes a framework including a bottom bordered by two lateral edges; an adjustable end-stop device supported by the framework; and an automatic drive mechanism configured to drive the lottery tickets. The automatic drive mechanism includes a driving geartrain is accessible from outside the framework so that the driving geartrain can be activated by an external device.

### BRIEF DESCRIPTION OF THE SEVERAL VIEW OF THE DRAWINGS

Exemplary implementations of the present disclosure are indicated in the description illustrated by the following figures.

FIG. 1 is a schematic perspective depiction of a cassette according to one example embodiment of the present disclosure.

FIG. 2 is a schematic depiction of a detail of the cassette of one example embodiment of the present disclosure.

FIG. 3 is a schematic depiction of a locking system of the cassette of one example embodiment of the present disclosure.

FIG. 4 is a depiction, in profile, of a rear end-stop of the cassette of one example embodiment of the present disclosure.

FIG. 5 is a detailed depiction of a front part of the cassette of one example embodiment of the present disclosure.

FIG. 6 is a perspective depiction of a drive system of the cassette of one example embodiment of the present disclosure.

FIG. 7 is a depiction, in profile, of the cassette of one example embodiment of the present disclosure and of a booklet of lottery tickets placed inside the cassette.

FIGS. 8a and 8b depict a manual drive system of the cassette of one example embodiment of the present disclosure in an active mode and in an inactive or released mode.

FIG. 9a is a perspective depiction of the cassette of one example embodiment of the present disclosure during the dispensing of lottery tickets.

FIG. 9b is a depiction, in profile, of the cassette of one example embodiment of the present disclosure as a lottery ticket is being withdrawn after dispensing.

FIG. 10 is a schematic depiction of a lottery ticket detection system that can be employed with the cassette of one example embodiment of the present disclosure.

### DETAILED DESCRIPTION

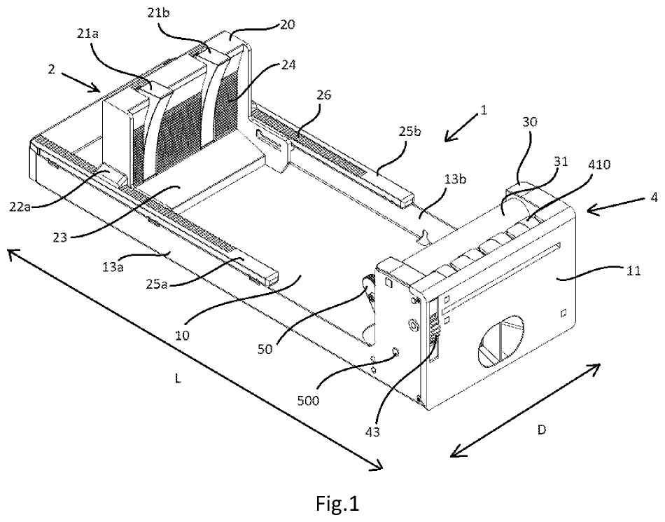

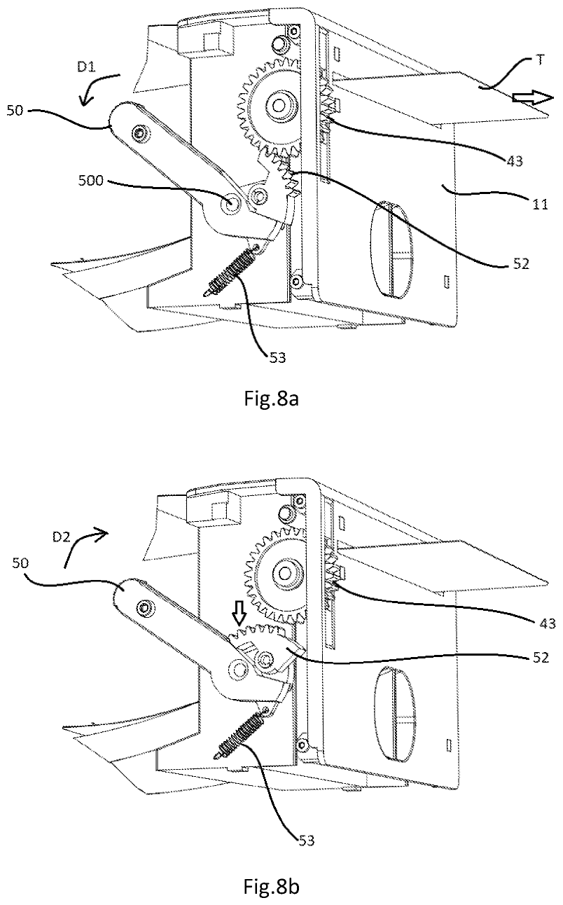

FIGS. 1 to 9b show a cassette 1 according to one example embodiment of the present description, wherein the cassette 1 is configured for the storage and automatic dispensing of lottery tickets T, particularly lottery tickets packaged as booklets (such as in a fan folded sequence). In such an arrangement, the lottery tickets are joined one after the other to form a strip of lottery tickets, wherein various lottery tickets are each folded back on itself at regularly spaced folds. Such a cassette is suitable for an automatic dispenser comprising for example a mobile robot along the front, such as but not limited to the automatic dispenser described in PCT Published Patent Application WO2020/152560. It can nevertheless be adapted to suit other lottery ticket dispensers. In particular, one or more of the elements of the present cassette described here are compatible with several types of dispensers.

It should be appreciated that one advantage of the present disclosure is to provide a device and/or a method that is free of the above-mentioned limitations. In particular, one advantage of the present disclosure is to provide a lottery ticket dispensing system, and more particularly a cassette, that can be adapted to suit a wide variety of lottery ticket dimensions. The present disclosure more particularly seeks to offer a lottery ticket dispensing system that can be adapted while at the same time ensuring proven reliability in the dispensing of the lottery tickets. One advantage in this instance is to ensure that the lottery ticket or tickets purchased by a consumer are dispensed without error or blockage.

Another advantage of the present disclosure is to provide a system and/or a method for dispensing lottery tickets that makes it possible to limit the handling and/or operating costs associated with the automatic dispensing of lottery tickets.

This cassette of the present disclosure offers the advantage over various known dispensing systems in that it is more compact, more flexible, and/or less expensive for the automatic dispensing of lottery tickets. Further advantages will be explained in the description below.

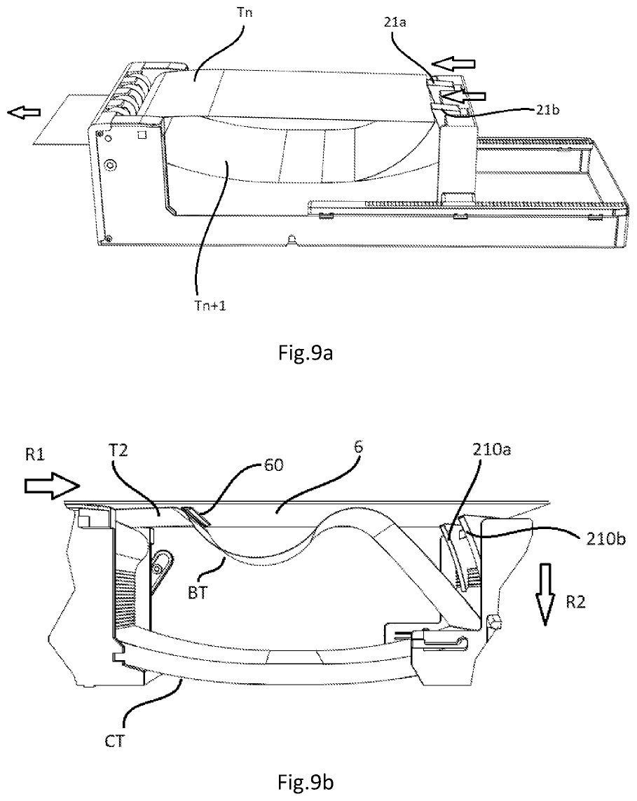

More specifically, the cassette 1 according to this example embodiment of the present description comprises a framework having a bottom 10 bordered by two lateral edges 13a and 13b and a front face 11. The cassette 1 has a static rear face 12 facing the front face 11. The heights of the various front face 11, rear face 12, and lateral faces 13a and 13b are adapted as required. According to one embodiment, the lateral faces 13a and 13b are lowered compared with the front face 11. The rear face 12 may be as tall as the front face 11, so as, for example, to allow a cover 6 (such as shown in FIG. 9b) to be fitted onto it.

The cassette 1 according to this example embodiment of the present description comprises an adjustable end-stop device 2 able to move relative to the framework. The adjustable end-stop device 2 in this instance enables the lottery tickets to be arranged in a suitable dispensing position so that they do not move or deviate during dispensing. The adjustable end-stop device 2 further makes it possible to adapt to different sizes of lottery ticket T while at the same time securing the dispensing of same. One example of an adjustable end-stop device 2 is illustrated in FIGS. 1 to 3. It comprises a rear end-stop 20 configured to hold the lottery tickets T in position in the cassette 1. The rear end-stop 20 comprises a first bearing surface 24 oriented vertically. The rear end-stop 20 comprises one or more of the positioning devices 22a and 22b enabling it to be placed in a determined position along the framework of the cassette 1 and one or more locking devices 27a and 27b enabling the rear end-stop to be held removably in its position. The first bearing surface 24 can advantageously comprise retaining grooves 240, arranged horizontally, to better hold the edge faces of the lottery tickets T when they are in contact with the rear end-stop 20.

The adjustable end-stop device 2 further comprises one or more positioning references 25a and 25b securely connected to the framework and making it possible to determine a position of the rear end-stop 20 along the framework. In particular, the positioning references 25a and 25b can collaborate with the positioning devices 22a and 22b of the rear end-stop 20. The positioning references 25a and 25b and the positioning devices 22a and 22b of the rear end-stop 20 can thus easily be secured and disconnected. According to one embodiment, all that is required for the rear end-stop 20 to maintain a determined position on the framework is for the positioning references 25a and 25b and the positioning devices 22a and 22b to be brought into contact with each other.

The positioning references 25a and 25b may each adopt the form of one or more horizontal surfaces provided with positioning ribs 26 over which the positioning devices 22a and 22b can move to adopt a determined position there. For this purpose, the positioning devices 22a and 22b may each comprise at least one surface provided with anchoring ribs 26′ of a profile that complements that of the positioning ribs 26 so that the anchoring ribs 26′ anchor in the positioning ribs 26 under the simple effect of gravity. Furthermore, a return force can be exerted, for example by way of one or more spring leaves such as the spring leaves 270a and 270b described below. Once the booklet of lottery tickets has been installed between the front and rear end-stops, particularly once a curvature CT has been applied to the booklet of lottery tickets, the force exerted by the curved lottery tickets on the rear end-stop 20 keeps the anchoring ribs pressed against the positioning ribs. The pressure exerted by the lottery tickets contributes to holding the rear end-stop 20 in position.

According to one embodiment, the horizontal surface or surfaces corresponding to the positioning references 25a and 25b are arranged on at least a portion of the upper edge corner of the lateral faces 13a and 13b. The positioning ribs 26 are thus visible and accessible from an upper position. The positioning devices 22a and 22b may adopt the form of two tabs or protrusions on each side of the rear end-stop 20 the lower surface of which is provided with the anchoring ribs 26′. The horizontal surface or surfaces corresponding to the positioning references 25a and 25b are in various embodiment arranged on a posterior portion of the framework, such as the rear half or the rear two-thirds of the framework. In that way, the rear end-stop 20 can move from a maximum posterior position to a more anterior position on the framework to adapt to the length of the lottery tickets T that it is intended to hold.

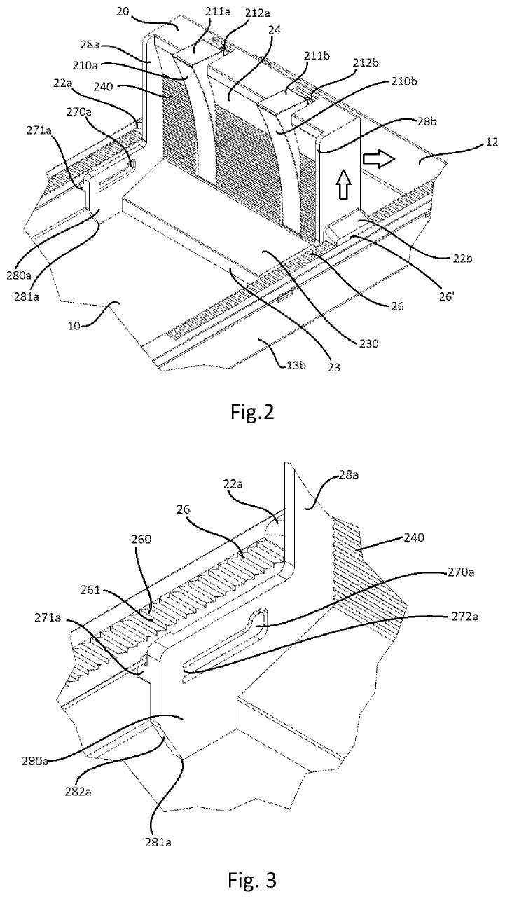

FIG. 2 shows a more particular embodiment in which the positioning ribs 26 are asymmetrical. They each comprise a slightly inclined sliding surface 260, and a stop surface 261 that is vertical or near vertical. The inclination of the sliding surface 260 is arranged in such a way as to enable the rear end-stop 20 to slide from a rear position of the cassette 1 towards a more anterior position without the need to disconnect the positioning devices 22a and 22b from the positioning references 25a and 25b. The stop surface 261 is arranged in such a way as to prevent the rear end-stop 20 from moving towards a posterior position once it has been placed at a determined position in the framework. The anchoring ribs 26′ have a profile that complements that of the positioning ribs 26. This arrangement may advantageously be used in addition to or as a replacement for other locking devices. Other arrangements may be envisaged, such a symmetrical rib enabling sliding in both directions, or, on the other hand, blocking the movements of the rear end-stop in both directions.

In various embodiments, the cassette comprises one or several locking devices. Such a locking device may be needed when the positioning ribs 26 do not have a way for blocking the backward movement of the rear end-stop 20. Such locking devices may nevertheless be used in addition to the asymmetrical positioning ribs 26 or other manners making it possible to block the backward movement of the rear end-stop 20. The locking device or devices are arranged in such a way as to hold the rear end-stop 20 in place in a determined position on the framework of the cassette 1 and to counter the pressure of the lottery tickets T when they are placed in the cassette 1. The locking device or devices further make it possible to block the spontaneous movement of the rear end-stop towards a more anterior position on the framework.

According to one embodiment, the locking device or devices comprise one or more locking surfaces 280a and 280b secured to the rear end-stop 20 and arranged near the lateral edges 13a and 13b. The locking device or devices can be arranged inside the framework. The locking surfaces 280a and 280b are each provided with a spring element such as spring leafs 270a and 270b able to bear against the interior face of the lateral edges 13a and 13b. The spring leafs 270a and 270b may be integrated into the corresponding locking surfaces 280a and 280b by one or more hinge points 272a and 272b. The locking surfaces 280a and 280b may further be provided with one or more locking end-stops 271a and 271b able to collaborate with the corresponding lateral edges 13a and 13b or with the positioning references 25a and 25b arranged on the lateral edges where appropriate. The locking surfaces 280a and 280b of the locking device are in contact with the bottom 10 of the framework at one or more pivot points 281a and 281b on which the rear end-stop 20 can pivot. The pivot point or points 281a and 281b are in various embodiments positioned in an anterior position relative to the bearing surface 24 of the rear end-stop 20. The positioning devices 22a and 22b of the rear end-stop 20 are positioned at a position posterior to the pivot points 281a and 281b. In that way, the positioning devices 22a and 22b can be disconnected from the positioning references 25a and 25b by making the rear end-stop 20 pivot on its pivot point or points 281a and 281b. Once the positioning devices 22a and 22b have been disconnected from the positioning references 25a and 25b by the pivoting of the rear end-stop 20, the rear end-stop can easily be moved backwards or forwards in the framework until it reaches a suitable position. Pivoting it back to the vertical enables the positioning devices 22a and 22b to be secured once again to the positioning references 25a and 25b simply under the effect of gravity.

According to one embodiment, the spring leaf or leaves 270a and 270b contribute to keeping the rear end-stop 20 in position.

Aside from the advantage of holding the rear edge faces of the lottery tickets T by way of its bearing surface 24, the rear end-stop 20 may be provided with one or more lateral lips 28a and 28b that enable lateral retention of the lottery tickets T. One or more lips 28a and 28b may lie within the continuation of the corresponding locking surfaces 280a and 280b described above. Nevertheless, other arrangements can be employed.

The rear end-stop 20 according to various embodiments of the present disclosure can comprise a rear end-stop baseplate 23 in a lower position and protruding relative to the first bearing surface 24 of the rear end-stop 20. The rear end-stop baseplate 23 can be in contact with the bottom of the framework 10 and has a first baseplate surface 230 on which the end of the lottery tickets T placed in the cassette 1 can rest. In this particular instance, the posterior end of the lowermost lottery ticket T of the ticket booklet, which rests directly on the bottom of the framework, rests on the baseplate surface 230, and this induces a curvature CT in all of the lottery tickets of the booklet. The dimensions and the shape of the rear end-stop baseplate 23 are determined in such a way as to produce the requisite curvature CT for the lottery tickets T. The length by which the rear end-stop baseplate 23 advances into the framework can vary from a few millimetres to a few centimetres as required. The rear end-stop baseplate 23 can for example advance as far as the pivot points 281a and 281b of the locking surfaces 280a and 280b described above. Alternatively, the rear end-stop baseplate 23 can be set back relative to the pivot points of the locking surfaces or extend beyond the locking surfaces. According to one embodiment, the lower part of the rear end-stop baseplate 23 can act as a pivot point in addition to or as a replacement for the pivot points 281a and 281b of the locking surfaces 280a and 280b. According to one embodiment, the first baseplate surface 230 extends from one locking surface to the other. Nevertheless, other arrangements can be employed, such as, for example, a discontinuous surface, or simple support rails on which the tickets T can rest. The first baseplate surface 230 can be inclined towards the front to raise further the end of the lottery tickets in contact with the first bearing surface 24 of the rear end-stop 20. The height of the rear end-stop baseplate 23 is also able to be adapted as required. As a preference, the height of the rear end-stop baseplate 23 remains below the positioning references 25a and 25b.

According to one embodiment, the rear end-stop 20 described herein comprises one or more guide fingers 21a and 21b making it possible to maintain contact with the stack of tickets T whatever the height thereof. The guide finger or fingers 21a and 21b are also configured to accompany the lottery tickets T as they are being dispensed, notably by maintaining contact with their end over part of their travel as they are being paid out. The guide finger or fingers 21a and 21b can be arranged in the rear end-stop 20 retractably. To achieve that, one or more recesses are formed in the rear end-stop 20 to make it possible to house the guide finger or fingers 21a and 21b therein and one or more spring mechanisms 212a and 212b are arranged therein to push the corresponding guide finger or fingers 21a and 21b out of their housing into a position anterior to the first bearing surface 24. When lottery tickets T are placed in the cassette and the first bearing surface 24 of the rear end-stop 20 is brought into contact with them, the guide finger, or fingers 21a and 21b are in a retracted position, because of the pressure from the lottery tickets T. The guide finger or fingers 21a and 21b can be arranged vertically to have contact with the booklet of lottery tickets T over at least a part of its height. They may extend over the entire height of the first bearing surface 24 or over just a portion of its height. In the latter instance, they can be arranged in the upper part of the rear end-stop 20.

The deflection of the guide finger or fingers 21a and 21b may be lottery consistent over their entire length, notably if they cover only an upper portion of the rear end-stop 20. In that way, they are configured to accompany the upper lottery tickets out of the cassette 1. With this arrangement, the movement of the guide finger or fingers 21a and 21b is a translational movement.

Alternatively, the deflection of the guide finger or fingers 21a and 21b is progressive along their length, as detailed for example in FIG. 3. In various embodiments, the fingers are each configured at a maximum at their upper end, to accompany the upper tickets as they are being dispensed, and at a minimum or nil at their base, so as not to be impeded by the lottery tickets at the bottom of the stack. With this arrangement, the movement of the guide finger or fingers 21a and 21b are a pivoting from their base.

The most-deployed position of the guide fingers 21a and 21b is determined as required. It may for example correspond to the width of the lateral lips 28a and 28b or indeed extend beyond the lateral lips 28a and 28b to accompany the lottery tickets in the process of being dispensed over a substantial proportion of their travel. In general, the longer the travel of the guide finger or fingers the more securely the lottery tickets T are guided. The length and shape of the guide fingers 21a, 21b are adapted such that the ticket Tn+1 following the ticket Tn that is in the process of being dispensed remains curved with the curvature CT or close to the curvature CT, namely a concave shape. At the very least, to prevent the ticket Tn+1 from resisting during the withdrawal described later, the ticket Tn+1 with such arrangements does not adopt an opposite curvature, in other words a convex curvature. Maintaining a concave curvature CT under all circumstances, for example for any thickness of ticket booklet and for any size of ticket also makes it possible to avoid jamming as the tickets are being dispensed.

According to one embodiment, the anterior surfaces 210a and 210b of each of the guide fingers 21a and 21b is curved to improve the sliding of the lottery tickets as they are being dispensed and/or to increase the distance of accompaniment. The anterior surfaces 210a and 210b are concave in various embodiments so that the deflection of each of the guide fingers is at a maximum at their upper ends 211a and 211b (as shown in FIG. 2).

The cassette 1 according to the present description can comprise a front end-stop 30 facing the rear end-stop 20 described above, which is visible for example in FIG. 5. The front end-stop 30 is aimed at retaining the front edge face of the lottery tickets T placed in the cassette 1. The front end-stop 30 can be attached in various embodiment on the framework and positioned just behind the front face 11 of the cassette 1. It thus provides guidance for the advancing of the lottery tickets T through the front face as they are being dispensed. The front end-stop 30 for this purpose comprises a second bearing surface 34 for the lottery tickets, facing the first bearing surface 24 of the rear end-stop 20. The lottery tickets T may be brought to bear both against the second bearing surface 34 and the first bearing surface 24 when the rear end-stop 24 is advanced into a ticket retaining position. The second bearing surface 34 may have striations, grooves 340, or any other relief suited to the retention of the lottery tickets T.

The front end-stop 30 advantageously has a guide surface 31 arranged transversely to the cassette 1 in the upper position of the front end-stop 30, suitable for holding the lottery ticket T in a determined orientation as it is being dispensed. The guide surface 31 may be static and of cylindrical or semicylindrical or rounded shape, with no corners that could damage the lottery ticket T as it is being dispensed. Alternatively, the guide surface 31 may be a rotationally mobile element such as a cylindrical roller or a series of coaxial rollers limiting friction against the lottery ticket as it is being dispensed. The guide surface 31 may be continuous over the entire width of the front end-stop 30 or cover just one or a quantity of portions of the width of the front end-stop 30, as required.

According to one embodiment, the front end-stop 30 comprises a front end-stop baseplate 33 arranged in a posterior position relative to the second bearing surface 34 to raise the end of the lottery tickets T in contact with the second bearing surface 34. After the manner of the rear end-stop baseplate 23, the shape and the dimensions of the front end-stop baseplate 33 may be modulated as required in a similar way to the rear end-stop baseplate 23. In this instance, the front end-stop baseplate 33 may have a second inclined surface 330 so that the end of the lottery tickets in contact with the second bearing surface 34 is raised while resting on the surface 330.

According to one embodiment, the front end-stop 30 comprises a mechanism for limiting or avoiding lateral movement of the lottery tickets T placed in the cassette. For that purpose, it may comprise one or more lateral lips 38a and 38b adjoining the second contact surface 34.

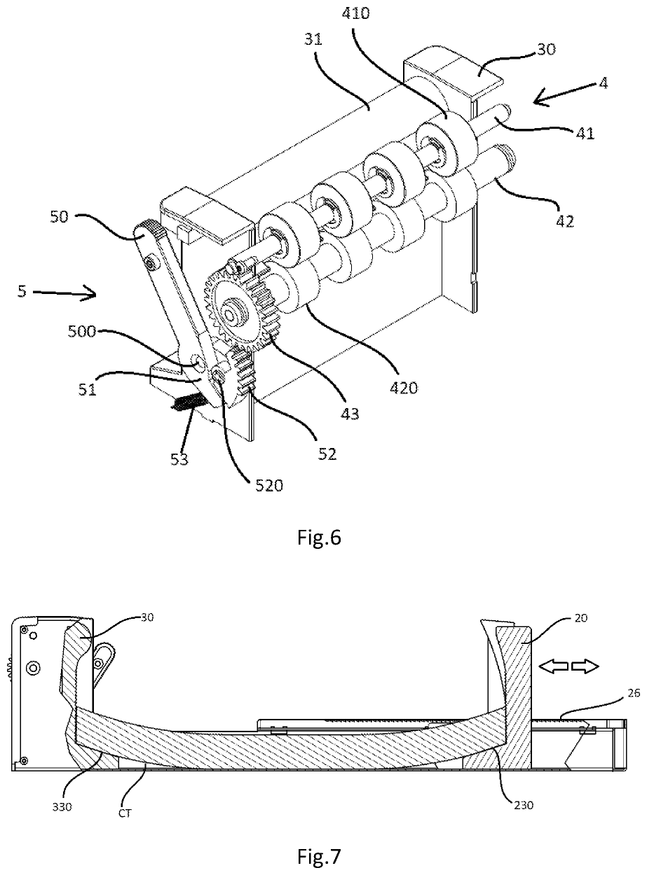

According to one embodiment, the present cassette comprises a drive mechanism 4 (such as shown in FIG. 6) configured to automatically drive the lottery tickets T as they are being dispensed. In particular, the drive mechanism 4 is configured to collaborate with an external device such as a robot or other activating mechanism, for activating it. The drive mechanism 4 therefore comprises a set of driving geartrains arranged in the cassette 1, such as at the front face 11. The first 41 and second 42 drive spindles can, for example, be positioned between the front face 11 of the framework and the front end-stop 30 or integrated into the front face 11. They may thus be activated from the outside. The automatic drive mechanism 4 comprises a first drive spindle 41 and a second drive spindle that is parallel to the first drive spindle 41. The first and second drive spindles are arranged transversely to the framework to be able to drive the lottery tickets T in a translational movement through the front face 11. The automatic drive mechanism 4 further comprises one or more driving geartrains 43 secured to one of the first and second drive spindles 41 and 42.

According to one particular arrangement, the first drive spindle 41 may be secured to one or more first drive cylinders 410, the second drive spindle 42 may be secured to one or more second drive cylinders 420 positioned facing the first drive cylinder or cylinders 410 to grip hold of a lottery ticket T and drive it out of the cassette 1. The term drive cylinder may, in an equivalent manner, refer to rollers or any similar element able to drive the lottery tickets. The driving geartrain 43 is accessible from outside the framework, in this instance accessible from the front face 11 so that it can be activated by a robot or other activating mechanism (such as an automated external device).

According to one embodiment, the drive mechanism 4 comprises a manual drive device 5 notably able to facilitate the placement of the lottery tickets T in the cassette 1. The manual drive device 5 for this purpose comprises a lever 50 mounted with the ability to pivot on a lever spindle 500 secured to the framework. The lever is readily accessible to an operator when the cassette is opened or extracted from the ticket dispenser. It may for example be positioned on one side of the front end-stop or of the front face. The manual drive device 5 comprises an actuator 52 mounted with the ability to pivot on an actuator spindle 520 secured to the base 51 of the lever 50. The actuator 52 is arranged in such a way as to be able to interact with the driving geartrain 43 when manually actuated and to be able to be disconnected therefrom when activated automatically. The manual drive device 5 comprises a return spring 53 of which one end is secured to the framework and the other end is secured to the lever 50, particularly at the base 51 of the lever.

The actuator 52 that is arranged near a driving geartrain 43 enables this geartrain to be driven when the lever 50 is rotated in a first direction. For example, when an operator pulls the lever 50 towards the rear of the cassette 1, the actuator spontaneously engages with the driving geartrain 43. The actuator 52 is arranged so that it spontaneously disengages from the driving geartrain 43 when the lever 50 is rotated in a second direction opposite to the first direction. In this instance, when an operator raises the lever 50 towards the front of the cassette 1, the actuator 52 is free to rotate about its spindle 520 and disengages from the driving geartrain 43 under the simple effect of gravity.

According to one particular arrangement, the actuator 52 is configured to drive a driving geartrain 43 through a predetermined angular extent suitable for positioning the edge of the first lottery ticket in a predetermined position. The lottery ticket T may for example be placed flush with the front face 11 in a repeatable manner. The actuator 52 may adopt the form of a toothed circular arc comprising a determined number of teeth to cause the driving geartrain 43 to rotate through a constant angle as the lever 50 is lowered to the end of its travel.

According to one embodiment, the cassette according to the present description comprises a removable cover 6 (such as shown in FIG. 9b). The cover 6 may for example rest on the upper edges of the front and rear faces of the cassette 1. The cover in this instance protects the lottery tickets once they are installed inside the cassette. It also allows the cassette already loaded with lottery tickets to be transported from a loading point to an automatic ticket dispenser. In this respect, the cover may comprise a locking system (not depicted) to prevent theft or loss of lottery tickets during any travel. Other equivalent measures may also be envisioned.

According to one arrangement, the cover 6 advantageously contributes to the guidance or reliability of the dispensing of the lottery tickets T. The cover 6 may on its underside comprise at least one boss 60, arranged on the forward portion of the cover 6, at a location posterior to the guide surface 31 of the front end-stop 30. The distance with respect to the front end-stop 30 is determined in such a way as to cause the lottery ticket T to adopt an inflection as it moves through the front face 11. The movement of the lottery ticket is therefore precisely controlled. In particular, during its retraction, described below, the lottery ticket does not adopt an arched shape or convex curvature that would offer excessive resistance to the retraction of the ticket. On the contrary, the boss or bosses 60 induce a wave shape more favourable to the retraction of the ticket. According to one embodiment, the cassette according to the present description has no cover. In that case, the housing into which the cassette is inserted is provided with an identical or similar device on its upper wall.

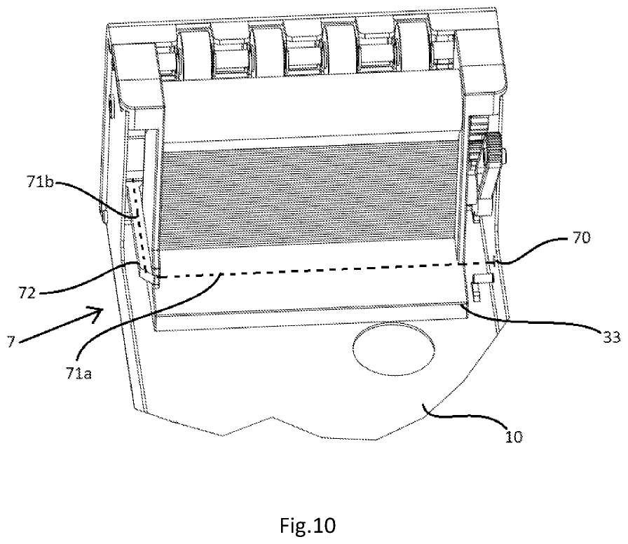

The cassette according to the present description may comprise an automatic-detection mechanism 7 detecting the presence of a booklet of lottery tickets T (such as shown in FIG. 10). Such a detection mechanism may comprise an optical device. According to one embodiment, the automatic-detection mechanism 7 comprises a light-emitting source 70 and an emitted-light reflecting device 72 arranged opposite, for example on the lateral edges 13a and 13b of the cassette 1 at a suitable height for detecting the presence or absence of lottery tickets. When no light is transmitted by the reflection device 72, lottery tickets are considered to be present and to be interrupting the beam of light. When the contrary is true, the absence of a lottery ticket in the path of the light is detected. The light-reflecting device is advantageously arranged in such a way as to redirect the light signal emitted in a direction 71a transverse to the cassette in a detection direction 71b different from the transverse direction 71a, for example towards the front face 11. A simple opening in the front face level with the beam of light allows an operator to detect from outside whether tickets are present or absent. Thus, the cassette 1 according to various embodiments of the present disclosure makes it possible to dispense with the need for electronic sensors which are liable to increase its cost. The height of the beam of light may be determined in such a way as to detect the complete absence of tickets or else a low level of tickets to draw attention to the need to fill the cassette in the near future. Alternatively, several beams of light may be provided, so that the change in level of tickets available in the cassette 1 can be monitored.

Alternatively, or in addition, a sensor may be positioned facing the beam of light to automatically determine the presence or absence of lottery tickets in the cassette. Such a sensor may be integrated for example into a mobile element of the ticket dispenser, such as a robot.

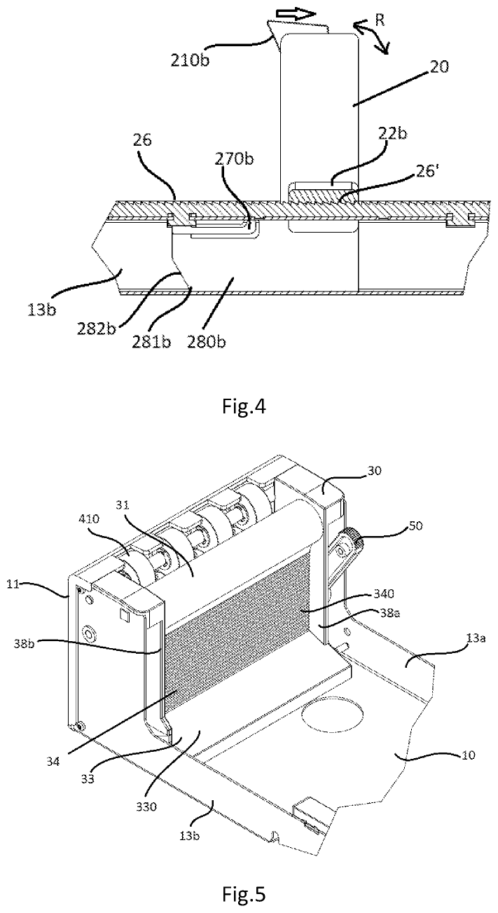

The present description also covers a method (partly shown in FIG. 7) for loading lottery tickets T into a cassette 1 as described hereinabove. The method in this instance comprises a step of positioning a booklet of lottery tickets T in the framework between the front 30 and rear 20 end-stops. To do this, the rear end-stop 20 may be moved towards the rear of the cassette 1, as described above, to leave the necessary space for the placement of the booklet of lottery tickets T. In this particular instance, the moving of the rear end-stop 20 towards the rear face 12 of the framework involves the pivoting R (FIG. 4) of the rear end-stop 20 on its pivot point or points 281a, 281b so as to disengage the anchoring ribs 26′ from the positioning ribs 26 and unlock the locking devices 27a and 27b, the rear end-stop adopting an inclined-forwards position, the moving of the rear end-stop 20 towards the rear face 12 of the framework while keeping the rear end-stop 20 in its inclined position, and the releasing of the rear end-stop 20 into its initial vertical orientation so that the anchoring ribs 26′ once again anchor in the positioning ribs 26 under the simple effect of gravity.

The method comprises the step of adjusting the longitudinal position of the rear end-stop 20 to bring the first bearing surface 24 into contact with the posterior edge of the lottery tickets T. To do this, the rear end-stop 20 may be simply slid forwards on the positioning ribs 26 until it wedges the tickets between the first bearing surface 24 and the second bearing surface 34. Alternatively, the rear end-stop may be tilted on its pivot point or points before being moved forwards and then placed back on the positioning references 25a and 25b. The guide finger or fingers 21a and 21b are then in the retracted position retracted inside the rear end-stop 20. One or both ends of the lottery tickets may be raised by the corresponding baseplates, where present. The curved arrangement of the lottery tickets contributes to maintaining the position of the rear end-stop 20. Further, the curved position of the lottery tickets limits the risks of jamming or other dispensing faults, as set out hereinabove.

The method comprises the step of locking the longitudinal position of the rear end-stop 20 to hold the booklet of lottery tickets in place and ensure that the lottery tickets are dispensed reliably. The position locking may be obtained automatically by the anchoring of the anchoring ribs 26′ of the rear end-stop 20 on the positioning ribs 26 of the positioning reference. Alternatively, or in addition, the locking of the position of the rear end-stop 20 may be obtained by virtue of the locking surfaces 280a and 280b described above, with their locking end-stops 271a and 271b and their spring leaves 270a and 270b.

According to one embodiment, the present method makes it possible to safeguard the positioning of the first ticket when an operator loads the cassette. The positioning of the first ticket involves the step of bringing the end of the first ticket T1 into contact with the first 410 and second 420 drive cylinders of the automatic drive mechanism 4. It involves the step of actuating the lever 50 by rotating it in a first direction D1 so that the actuator 52 engages with the driving geartrain 43 and drives same through a predetermined angular extent. The travel of the lever 50 may be calibrated accordingly. It then involves the step of rotating the lever 50 in a second direction D2 opposite to the first direction. According to one advantageous embodiment, all the operator needs to do is release the lever 50 and it will automatically return to its initial position notably by virtue of the return spring 53 described above or via any other equivalent mechanism. As the lever 50 returns in the second direction D2, the actuator 52 automatically disengages from the driving geartrain 43 under the simple effect of gravity.

The present method also targets the reliable dispensing of one or more lottery tickets T1 and T2, Tn in booklet form (such as shown in FIGS. 9a and 9b). The dispensing method comprises the step of driving the free end of a first lottery ticket or group of lottery tickets T1 out of the cassette using the automatic drive mechanism 4. The end of the first lottery ticket or group of lottery tickets that is connected to the rest of the booklet is kept in contact with the guide finger or fingers 21a and 21b that accompany the driving thereof by leaving their housings under the thrusting force of the springs 212a and 212b.

According to one embodiment, the first lottery ticket or group of lottery tickets T1 is driven out of the cassette 1 over a length greater than the length of the lottery ticket or group of lottery tickets T1 concerned. In other words, the joint connecting the lottery tickets or group of lottery tickets to the remainder of the booklet is outside the cassette. It is thus possible to detach the lottery ticket or group of lottery tickets T1 from the rest of the booklet using a mechanical or automatic mechanism. The drive mechanism 4 is then activated in the opposite direction to cause the free end of the next lottery ticket T2 that remains in the cassette 1 to retract. The retraction is performed over a retraction distance R1, so that the connected end of the next lottery ticket T2 folds over onto the booklet in a vertical sliding movement R2 (such as shown in FIG. 9b). The vertical sliding movement R2 is accompanied or encouraged by the anterior surfaces 210a and 210b of the guide finger or fingers 21a and 21b of the rear end-stop 20.

Where applicable, the vertical sliding movement R2 of the next lottery ticket T2 may be assured or assisted by the boss 60 of the underside of the cover 6 or, failing that, by an equivalent device integrated into the cassette housing. The deviation of the lottery ticket T2 over this boss causes a ticket kink BT, with its connected end being oriented towards a lower position against the rear end-stop 20. The resulting wave shape or the inverse double curvature provides better control over the path followed by the lottery ticket, particularly as it is retracted.

The steps of driving a first lottery ticket out of the cassette, of separating the first lottery ticket from the rest of the booklet and of retracting the free end of the remaining lottery ticket are repeated until the last lottery ticket of the booklet is dispensed according to consumer purchases. The height of the booklet of lottery tickets in the cassette progressively decreases. To ensure reliability of the dispensing of the lottery tickets, the present cassette makes it possible to maintain good guidance whatever the thickness of the booklet. To achieve this, the deployment of the guide finger or fingers 21a and 21b out of the rear end-stop 20 increases in pace with lottery ticket consumption. In that way, pressure is maintained throughout the driving of the lottery tickets in the process of being dispensed, and the vertical sliding movement (R2) of the lottery tickets as they are retracted (R1) is encouraged.

According to one embodiment, the present method includes detection of the presence or absence of lottery tickets T in a cassette. Detection is preferably performed by way of one or more optical devices, preferably without electronic sensors. Optical detection involves the step of emitting a light signal from a light source 70 positioned in a first lateral zone of the cassette, in a direction 71a transverse to the cassette. The light signal is directed towards the location of the lottery tickets in the cassette to make it possible to determine whether such lottery tickets are present or absent. The light signal is emitted at a height suitable for enabling detection of a booklet, or of a minimum number of lottery tickets, or of just one single ticket, depending on the detection threshold. The method comprises the step of determining the presence or absence of the light signal emitted at a position opposite to the light source in relation to the location of the tickets. According to one embodiment, the detection of the light signal is performed by way of a sensor located in a second lateral zone opposite the first lateral zone. According to another embodiment, the light signal is detected visually. To detect the presence or absence of lottery tickets without the need to open the cassette 1, the light signal is redirected towards the front face 11 of the cassette 1. To do this, a light reflector 72 may be positioned facing the light source 70 in a second lateral zone opposite to the first lateral zone. With such an arrangement, the light signal is deflected in a detection direction 71b different from the transverse direction 71a. According to one embodiment, the presence or absence of a light signal is determined automatically by a detector external to the cassette. For example, a dispensing robot, able to move past several cassettes, may be equipped with such a detector to determine whether or not it may engage the dispensing mechanism 4 of the cassette, according to whether lottery tickets are present in or absent from the cassette.

The first and second lateral zones are in various embodiment determined in such a way as to flank the location of the lottery tickets in the framework. The detection of the light signal by a sensor indicates an absence of lottery tickets in the cassette and/or a quantity of lottery tickets that is below a determined threshold.

For the purposes of the present description, terms such as “vertical”, “horizontal”, “lateral”, “upper”, “lower”, “anterior”, “posterior” and the related terms are to be understood in their common senses and are applicable to the object described here when it is in its position of use. In particular, the cassette 1 according to the present description is in its position of use when it is inserted in a ticket dispenser, with the bottom 10 in a lower position, the facade or front face 11 in a frontal position, facing the purchaser and the adjustable end-stop device 20 in a posterior position.

The various embodiments described here are not intended to be mutually exclusive. They may be considered individually or in combination with one another. Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

What is claimed is:

1. A cassette for storing booklets of lottery tickets, the cassette configured to be positioned in a lottery ticket automatic dispenser, the cassette comprising:
a framework comprising a bottom bordered by two lateral edges, by a front face, and by a rear face; and
an adjustable end-stop device supported by the framework, wherein the adjustable end-stop device comprises:
a rear end-stop comprising a lottery ticket first bearing surface, a positioning device, and a locking device,
a positioning reference secured to the framework and configured to co-act with the positioning device, the positioning reference positioned on a rear portion of the framework along a longitudinal axis so that the rear end-stop is positionable along said longitudinal axis, and
wherein the locking device is configured to keep the rear end-stop secured to the framework in a determined position.

2. The cassette of claim 1, wherein the locking device comprises a locking surface extending along one of the lateral edges inside the framework, the locking device comprising a spring leaf, and said lateral edge comprising on a surface internal to the framework a locking end-stop configured to co-act with the spring leaf.

3. The cassette of claim 1, wherein the locking device contacts the bottom of the framework at a pivot point, and wherein the positioning device positioned at a location rearwardly of the pivot point along the longitudinal axis.

4. The cassette of claim 1, wherein the rear end-stop comprises two lottery ticket retention lateral lips.

5. The cassette of claim 1, wherein the rear end-stop comprises a rear end-stop baseplate at a position forwardly of the lottery ticket first bearing surface, the baseplate comprising a first surface inclined towards the front face and configured to raise ends of lottery tickets in contact with the lottery ticket first bearing surface.

6. The cassette of claim 1, where the positioning reference comprises an upper surface with positioning ribs, and the positioning device comprises a lower surface with anchoring ribs of a profile that complements that of the positioning ribs so that the anchoring ribs can anchor in the positioning ribs.

7. The cassette of claim 1, wherein the lottery ticket first bearing surface comprises retaining grooves.

8. The cassette of claim 1, wherein the rear end-stop comprises a guide finger that is at least partially retractable into the rear end-stop, and a spring that biases the guide finger in a position forwardly of the lottery ticket first bearing surface.

9. The cassette claim 8, wherein the guide finger comprising a concave anterior surface, wherein travel of the guide finger is at a maximum at its upper end.

10. The cassette claim 1, which comprises a front end-stop secured to the framework, the front end-stop comprising a lottery ticket second bearing surface that faces the lottery ticket first bearing surface, the front end-stop comprising a guide surface positioned transversely to the framework in an upper position of the front end-stop.

11. The cassette claim 10, wherein the front end-stop comprises a front end-stop baseplate in a position rearwardly of the lottery ticket second bearing surface, the front end-stop baseplate comprising a second rearwardly inclined surface and configured to raise ends of lottery tickets in contact with said lottery ticket second bearing surface.

12. The storage cassette of claim 11, wherein said front end-stop comprising two lottery ticket retention lateral lips.

13. The cassette of claim 1, which comprises an automatic drive mechanism configured to drive the lottery tickets, the automatic drive mechanism comprising:
a first drive spindle oriented transversely to the framework,
a second drive spindle parallel to the first drive spindle, and
a driving geartrain secured to one of the first and second drive spindles,
wherein the first drive spindle is secured to a first drive cylinder and the second drive spindle is secured to a second drive cylinder facing the first drive cylinder.

14. The cassette of claim 13, wherein the driving geartrain is accessible from outside the framework so that the driving geartrain can be activated by an automated external device.

15. The cassette of claim 14, wherein the first and second drive spindles are positioned between the front face of the framework and a front end-stop.

16. The cassette of claim 15, wherein the drive mechanism comprises a manual drive device comprising:
a lever mounted pivotable on a lever spindle secured to the framework,
an actuator mounted pivotable on an actuator spindle secured to a base of the lever, and
a return spring secured to the framework and the secured to the lever,
the actuator positioned to drive the driving geartrain when the lever is rotated in a first direction, and to disengage from driving the driving geartrain when the lever is rotated in a second direction opposite the first direction.

17. The cassette claim 16, wherein the actuator is configured to drive the driving geartrain through a predetermined angular extent suitable to position an edge of the first lottery ticket in a predetermined position.

18. The cassette of claim 1, which comprises a boss supported by the framework and positioned to cause a kink of a lottery ticket that follows a dispensed lottery ticket.

19. A cassette for storing booklets of lottery tickets, the cassette configured to be positioned in an automatic dispenser, the cassette comprising:
a framework comprising a bottom bordered by two lateral edges, by a front face, and by a rear face;
an adjustable end-stop device supported by the framework, wherein the adjustable end-stop device comprises a rear end-stop comprising a lottery ticket first bearing surface, a rear end-stop baseplate at a position rearwardly to the lottery ticket first bearing surface, the baseplate comprising a first surface inclined towards the front face and configured to raise first ends of lottery tickets in contact with said lottery ticket first bearing surface; and
a front end-stop secured to the framework, the front end-stop comprising a lottery ticket second bearing surface that faces the lottery ticket first bearing surface, the front end-stop comprising a front end-stop baseplate in a position rearwardly of the lottery ticket second bearing surface, the front end-stop baseplate comprising a second rearwardly inclined surface and configured to raise second ends of lottery tickets in contact with said lottery ticket second bearing surface.

20. A cassette for storing booklets of lottery tickets, the cassette configured to be positioned in an automatic dispenser, the cassette comprising:
a framework comprising a bottom bordered by two lateral edges;
an adjustable end-stop device supported by the framework; and
an automatic drive mechanism configured to drive the lottery tickets, the automatic drive mechanism comprising a driving geartrain is accessible from outside the framework so that the driving geartrain can be activated by an external device.
